(19) United States
(12) Patent Application Publication
(10) Pub. No.: US 2026/0063444 A1
(43) Pub. Date: Mar. 5, 2026

(54) REAL-TIME MAP GENERATION IN UNSTRUCTURED ENVIRONMENTS

(71) Applicant: Field AI, Inc., Mission Viejo, CA (US)

(72) Inventors: Joshua SPISAK, Irvine, CA (US); David Fan, Lake Forest, CA (US); Chanyoung CHUNG, Santa Ana, CA (US)

(73) Assignee: Field AI, Inc., Mission Viejo, CA (US)

(21) Appl. No.: 19/319,353

(22) Filed: Sep. 4, 2025

Related U.S. Application Data
(60) Provisional application No. 63/690,819, filed on Sep. 5, 2024.

(51) Int. Cl. G01C 21/00; G06T 5/20; G06T 5/70; G06T 15/00; G06T 17/05

(52) U.S. Cl. CPC G01C 21/3841; G06T 5/20; G06T 5/70; G06T 15/005; G06T 17/05; G06T 2200/04; G06T 2210/56

(57) ABSTRACT

Sparse centralized real-time mapping for efficient belief state representations of complex geometry in unstructured environments is provided by a space mapping system which collects, from sensors, point cloud data having auxiliary identifying data, performs real-time voxelization and probabilistic modeling using a probability theory to account for uncertainty in the point cloud data, based on the auxiliary identifying data, to create a sparse 3D belief space representation map of the point cloud data, generates a 2D map from the sparse 3D belief space representation map, wherein the space mapping system includes at least one graphic processing unit (GPU) and at least one central processing unit (CPU) to perform the probabilistic modeling, and dynamically allocates processing operations of at least one of the voxelization and the probabilistic modeling of the point cloud data between the GPU and the CPU during operations to create the sparse 3D belief space representation map.

### CROSS-REFERENCE TO RELATED APPLICATION

This application claims priority to and the benefit of the filing date of provisional U.S. Patent Application No. 63/690,819, entitled “SYSTEM AND METHOD FOR REAL-TIME MAP GENERATION IN UNSTRUCTURED ENVIRONMENTS,” and filed on Sep. 5, 2024, the entire contents of which is hereby expressly incorporated herein by reference.

### TECHNICAL FIELD

The present disclosure is related generally to robotic mapping and, more particularly, is related to sparse centralized real-time mapping for efficient belief state representations of complex geometry in unstructured environments BACKGROUND

In the technical field of autonomous robotics, accurate and real-time mapping is essential for navigating complex and unstructured environments. One or more robots deployed in challenging conditions such as off-road terrains, disaster zones, and industrial sites require sophisticated mapping systems to understand their surroundings, avoid obstacles, and make informed decisions. Traditional mapping approaches struggle to cope with the dynamic and unpredictable nature of the complex and unstructured environments, highlighting a need for advancements in mapping technologies that efficiently handle large-scale data and adapt to rapidly changing conditions.

Traditional technical robotic mapping systems commonly rely on well-established methods such as Simultaneous Localization and Mapping (SLAM) and occupancy grid mapping. SLAM techniques use one or more sensors to simultaneously map an environment and localize the robot within it. While effective in controlled settings, these traditional robotic mapping systems are limited in their ability to handle highly dynamic and cluttered environments due to their reliance on fixed algorithms and data structures. Occupancy grid mapping techniques discretize the environment into a grid of cells, where each cell represents a probability of being occupied. The occupancy grid mapping is inefficient in terms of memory usage and processing power, particularly for large-scale environments.

A significant limitation creating technical problems for the traditional mapping systems is their reliance on the fixed algorithms and data structures, which are not easily adaptable to real-time changes. Once deployed, the traditional mapping systems have limited flexibility, making it difficult to adjust their mapping processes and features without significant reprogramming. Additionally, the traditional mapping systems struggle with high data volumes and rapid processing demands required for real-time updates, leading to slower response times and reduced accuracy in the maps generated, particularly in environments that are constantly changing.

In recent years, there has been a trend toward integrating one or more graphics processing units (GPUs) alongside one or more central processing units (CPUs) in mapping systems to improve performance. The one or more GPUs excel at handling parallel processing tasks, making the one or more GPUs suitable for real-time data processing and feature extraction. The one or more CPUs, on the other hand, manage a broader range of tasks, including overall system coordination and decision-making. While this dual-processor approach provides improvement in processing speed and flexibility, it also presents technical challenges, particularly in managing interoperability between GPU tasks and CPU tasks. Additionally, these systems may still fall short of the dynamic adaptability required for complex and rapidly changing environments.

There are various technical problems with the existing mapping systems in the prior art. In the existing technology, the existing mapping systems face several limitations. Many rely on the fixed algorithms and data structures, which are inflexible and difficult to adapt in real-time, limiting their effectiveness in the dynamic environments. Issues with the interoperability between the one or more GPUs and the one or more CPUs create bottlenecks, hindering efficient data processing and task management. Overall, the existing mapping systems may struggle with maintaining high performance, flexibility, and efficiency in complex and rapidly changing conditions.

Therefore, there is a need for a system to address the aforementioned technical problems by providing dynamic and flexible real-time mapping capabilities with the efficient data processing.

### SUMMARY

In one general aspect, the instant disclosure presents a space mapping system for map generation, including a processor and a memory in communication with the processor, the memory comprising executable instructions that, when executed by the processor alone or in combination with other processors, cause the space mapping system to perform functions of collecting, from a plurality of sensors coupled to the space mapping system, point cloud data having auxiliary identifying data, performing real-time voxelization and probabilistic modeling using a probability theory to account for uncertainty in the point cloud data, based on the auxiliary identifying data, to create a sparse 3D belief space representation map of the point cloud data, and generating a 2D map from the sparse 3D belief space representation map, wherein the space mapping system includes at least one graphic processing unit (GPU) and at least one central processing unit (CPU) configured to perform the probabilistic modeling in cooperation with one another, and the instructions further cause the space mapping system to dynamically allocate processing operations of at least one of the voxelization and the probabilistic modeling of the point cloud data between the at least one GPU and the at least one CPU during operations to create the sparse 3D belief space representation map.

In another general aspect, the instant disclosure presents a space mapping method for map generation, including collecting, from a plurality of sensors coupled to a space mapping system, point cloud data having auxiliary identifying data, performing real-time voxelization and probabilistic modeling using a probability theory to account for uncertainty in the point cloud data, based on the auxiliary identifying data, to create a sparse 3D belief space representation map of the point cloud data, and generating a 2D map from the sparse 3D belief space representation map. The space mapping system includes at least one graphic processing unit (GPU) and at least one central processing unit (CPU) configured to perform the probabilistic modeling in cooperation with one another, and the method further includes dynamically allocate processing operations of at least one of the voxelization and the probabilistic modeling of the point cloud data between the at least one GPU and the at least one CPU during operations to create the sparse 3D belief space representation map.

In yet another general aspect, the instant disclosure presents computer-readable storage medium having instructions stored thereon that, when executed by a processing system, perform a method including collecting, from a plurality of sensors coupled to a space mapping system, point cloud data having auxiliary identifying data, performing real-time voxelization and probabilistic modeling using a probability theory to account for uncertainty in the point cloud data, based on the auxiliary identifying data, to create a sparse 3D belief space representation map of the point cloud data, and generating a 2D map from the sparse 3D belief space representation map. The space mapping system includes at least one graphic processing unit (GPU) and at least one central processing unit (CPU) configured to perform the probabilistic modeling in cooperation with one another, and the method further includes dynamically allocate processing operations of at least one of the voxelization and the probabilistic modeling of the point cloud data between the at least one GPU and the at least one CPU during operations to create the sparse 3D belief space representation map.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

The drawing figures depict one or more implementations in accord with the present teachings, by way of example only, not by way of limitation. In the figures, like reference numerals refer to the same or similar elements. Furthermore, it should be understood that the drawings are not necessarily to scale.

FIG. 1 shows an exemplary block diagram representation of a network architecture depicting a system for a real-time map generation in unstructured environments in accordance with aspects of the present disclosure.

FIG. 2A shows an exemplary block diagram representation of the system as shown in FIG. 1 for the real-time map generation in the unstructured environments in accordance with aspects of the disclosure.

FIG. 2B shows an exemplary flow diagram representation of the system for the real-time map generation in the unstructured environments in accordance with aspects of the disclosure.

FIG. 3 shows a diagram of an example implementation of processing in the space mapping system of FIGS. 1, 2A and 2B for real-time map generation in accordance with aspects of the disclosure.

FIG. 4 shows a flowchart for implementing real-time map generation in accordance with aspects of the disclosure.

FIGS. 5A, 5B and 5C show reconfiguring operations using plugins for changing the map generation in accordance with aspects of the disclosure.

FIG. 6 shows operations for adjusting to environment changes in accordance with aspects of the disclosure.

FIG. 7 is a block diagram illustrating an example software architecture, various portions of which may be used in conjunction with various hardware architectures herein described in accordance with aspects of the disclosure.

FIG. 8 is a block diagram illustrating components of an example machine configured to read instructions from a machine-readable medium and perform any of the features described herein in accordance with aspects of the disclosure.

### DETAILED DESCRIPTION

In the following detailed description, numerous specific details are set forth by way of examples in order to provide a thorough understanding of the relevant teachings. It will be apparent to persons of ordinary skill, upon reading this description, that various aspects can be practiced without such details. In other instances, well-known methods, procedures, components, and/or circuitry have been described at a relatively high-level, without detail, in order to avoid unnecessarily obscuring aspects of the present teachings.

As discussed above, in accordance with implementations of the present disclosure, a technical solution for the above-mentioned technical problems for generating a real-time map in unstructured environments is disclosed.

In an implementation of the present disclosure, the system includes one or more hardware processors and a memory unit. The memory unit is operatively coupled to the one or more hardware processors. The memory unit includes a plurality of subsystems in form of machine-readable instructions executable by the one or more hardware processors. In order to provide instructions to one or more processors for carrying out processing for generating maps in unstructured environments in accordance with the present disclosure, the memory unit includes a plurality of subsystems including a data-obtaining subsystem, a data-handling subsystem, a mapping subsystem, a probabilistic belief-state generating subsystem, a Two-Dimensional (2D) projection subsystem, and a filter-applying subsystem.

In yet another implementation of the present disclosure, the data-obtaining subsystem is configured to obtain sensor data from one or more sensors. The data-obtaining subsystem ensures that diverse types of sensor data are gathered in real-time to accurately reflect surroundings of one or more machines. The data handling subsystem is configured to manage the obtained sensor data between one or more graphics processing units (GPUs) and one or more central processing units (CPUs). The data handling subsystem dynamically allocates processing tasks between the one or more GPUs and the one or more CPUs based on the nature of the sensor data and the computational load, ensuring optimal performance and flexibility in processing. The mapping subsystem is configured to process geometric, semantic, and generic feature embeddings at high speeds. The mapping subsystem leverages parallel processing capabilities of the one or more GPUs to handle large volumes of data, allowing it to generate detailed and high-resolution maps in real-time. The mapping subsystem processes geometric, semantic, and generic feature embeddings to create a comprehensive representation of the environment. The probabilistic belief-state generating subsystem is configured to apply one or more probabilistic models to the embeddings obtained from the real-time mapping. The 2D projection subsystem is configured to convert the complex 3D belief-state representation (3D map) into a more straightforward 2D map. The filter-applying subsystem is configured to apply filters to the 2D projections (2D maps).

For the purpose of promoting an understanding of the principles of the disclosure, reference will now be made to the implementation illustrated in the figures and specific language will be used to describe them. It will nevertheless be understood that no limitation of the scope of the disclosure is thereby intended. Such alterations and further modifications in the illustrated system, and such further applications of the principles of the disclosure as would normally occur to those skilled in the art are to be construed as being within the scope of the present disclosure. It will be understood by those skilled in the art that the foregoing general description and the following detailed description are exemplary and explanatory of the disclosure and are not intended to be restrictive thereof.

In the present document, the word “exemplary” is used herein to mean “serving as an example, instance, or illustration.” Any implementation of the present subject matter described herein as “exemplary” is not necessarily to be construed as preferred or advantageous over other implementations.

The terms “comprise”, “comprising”, or any other variations thereof, are intended to cover a non-exclusive inclusion, such that one or more devices or sub-systems or elements or structures or components preceded by “comprises . . . a” does not, without more constraints, preclude the existence of other devices, sub-systems, additional sub-modules. Appearances of the phrase “in an implementation”, “in another implementation” and similar language throughout this specification may, but not necessarily do, all refer to the same implementation.

Unless otherwise defined, all technical and scientific terms used herein have the same meaning as commonly understood by those skilled in the art to which this disclosure belongs. The system, methods, and examples provided herein are only illustrative and not intended to be limiting.

A computer system (standalone, client or server computer system) configured by an application may constitute a “module” (or “subsystem”) that is configured and operated to perform certain operations. In one implementation, the “module” or “subsystem” may be implemented mechanically or electronically, so a module include dedicated circuitry or logic that is permanently configured (within a special-purpose processor) to perform certain operations. In another implementation, a “module” or “subsystem” may also comprise programmable logic or circuitry (as encompassed within a general-purpose processor or other programmable processor) that is temporarily configured by software to perform certain operations.

Accordingly, the term “module” or “subsystem” should be understood to encompass a tangible entity, be that an entity that is physically constructed permanently configured (hardwired) or temporarily configured (programmed) to operate in a certain manner and/or to perform certain operations described herein.

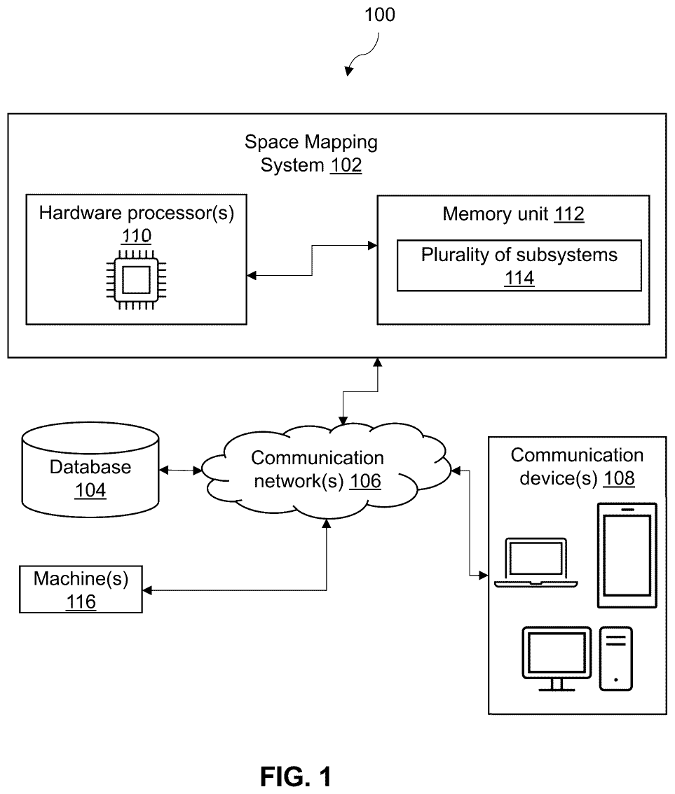

Referring now to the drawings, and more particularly to FIGS. 1-8, where similar reference characters denote corresponding features consistently throughout the figures, there are shown preferred implementations, and these implementations are described in the context of the following exemplary system and/or method and/or computer programming product.

FIG. 1 illustrates an exemplary block diagram representation of a network architecture 100 depicting a space mapping system 102 for a real-time map generation in unstructured environments, in accordance with an implementation of the present disclosure.

According to an exemplary implementation of the present disclosure, the network architecture 100 may include a space mapping system 102, one or more communication networks 106, a database 104, and one or more communication devices 108. The space mapping system 102 may be communicatively coupled to the database 104, and the one or more communication devices 108 via the one or more communication networks 106. The one or more communication networks 106 may be, but not limited to, a wired communication network and/or a wireless communication network.

The wired communication network may comprise, but not limited to, at least one of: Ethernet connections, Fiber Optics, Power Line Communications (PLCs), Serial Communications, Coaxial Cables, Quantum Communication, Advanced Fiber Optics, Hybrid Networks, and the like. The wireless communication network may comprise, but not limited to, at least one of: wireless fidelity (wi-fi), cellular networks (including 4G (fourth generation), 5G (fifth generation), and 6G (sixth generation) networks), Bluetooth, ZigBee, long-range wide area network (LoRaWAN), satellite communication, radio frequency identification (RFID), advanced IoT protocols, mesh networks, non-terrestrial networks (NTNs), near field communication (NFC), and the like.

The one or more communication networks 106 is configured to facilitate seamless data exchange and communication between the space mapping system 102 and the database 104 for real-time data analysis.

In an exemplary implementation, the database 104 may include, but not limited to, storing, and managing data related to the real-time map generation. The database 104 serves as a central repository for all relevant data, enabling efficient data retrieval and analysis to support decision-making processes. The database 104 also facilitates the real-time map generation for the one or more machines 116 in the unstructured environments, ensuring that the space mapping system 102 operates at peak efficiency. Furthermore, the database 104 may manage user access controls, configuration settings, and system logs, providing a comprehensive solution for data management and security within the network architecture 100. The database 104 is configured to implement a sparse hierarchical data structure that organizes and stores mapping data efficiently, reduces memory usage by focusing on storing only the most relevant and important data, and enabling the space mapping system 102 to scale to large environments without excessive memory consumption.

The one or more machines 116 is operatively connected to the space mapping system 102 via the one or more communication networks 106. The one or more machines 116 may be, but not restricted to, at least one of a: quadruped robot, wheeled robot, biped robot, drone, vehicle, and the like.

In an exemplary implementation, the one or more communication devices 108 may represent various network endpoints, such as, but not limited to, user devices, mobile devices, smartphones, Personal Digital Assistants (PDAs), tablet computers, phablet computers, wearable computing devices, Virtual Reality/Augmented Reality (VR/AR) devices, laptops, desktops, display interface panels, control panels, human machine interface panels, liquid crystal display (LCD) screens, light-emitting diode (LED) screens, and the like. The one or more communication devices 108 is configured to function as an intermediate unit between the space mapping system 102 and one or more users. The one or more communication devices 108 is equipped with a user interface that allows the one or more users to interact with the space mapping system 102. The user interface may include graphical displays, touchscreens, voice recognition, and other input/output mechanisms that facilitate easy access to data and control functions. Any other instructions may be provided by the one or more users to the space mapping system 102 via the user interface.

Though few components and a plurality of subsystems 114 are disclosed in FIG. 1, there may be additional components and subsystems which is not shown, such as, but not limited to, ports, routers, repeaters, firewall devices, network devices, the database 104, network attached storage devices, assets, machinery, instruments, facility equipment, emergency management devices, image capturing devices, any other devices, and combination thereof. The person skilled in the art should not be limiting the components/subsystems shown in FIG. 1. Although FIG. 1 illustrates the space mapping system 102, and the one or more communication devices 108 connected to the database 104, one skilled in the art can envision that the space mapping system 102, and the one or more communication devices 108 may be connected to several user devices located at various locations and several databases via the one or more communication networks 106.

Those of ordinary skilled in the art will appreciate that the hardware depicted in FIG. 1 may vary for particular implementations. For example, other peripheral devices such as an optical disk drive and the like, local area network (LAN), wide area network (WAN), wireless (e.g., wireless-fidelity (Wi-Fi)) adapter, graphics adapter, disk controller, input/output (I/O) adapter also may be used in addition or place of the hardware depicted. The depicted example is provided for explanation only and is not meant to imply architectural limitations concerning the present disclosure.

Those skilled in the art will recognize that, for simplicity and clarity, the full structure and operation of all data processing systems suitable for use with the present disclosure are not being depicted or described herein. Instead, only so much of the space mapping system 102 as is unique to the present disclosure or necessary for an understanding of the present disclosure is depicted and described. The remainder of the construction and operation of the space mapping system 102 may conform to any of the various current implementations and practices that were known in the art.

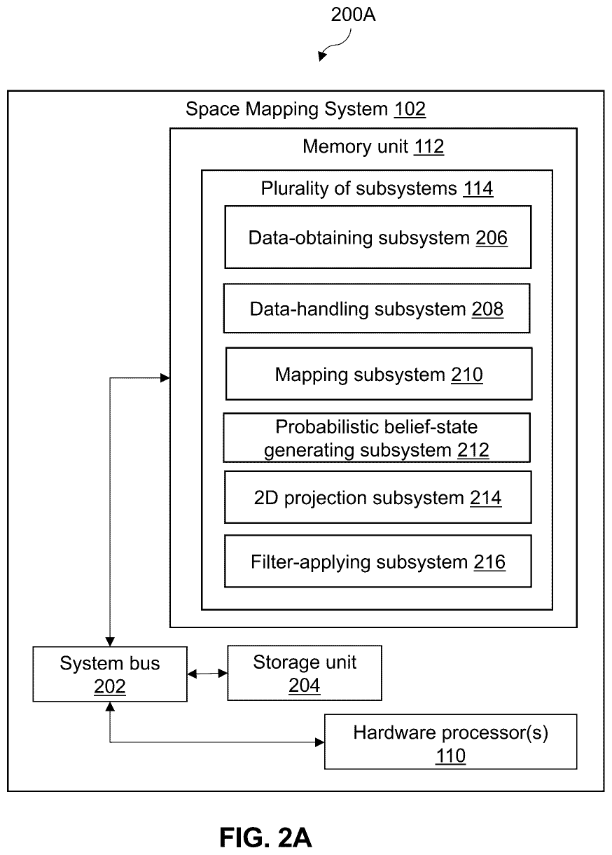

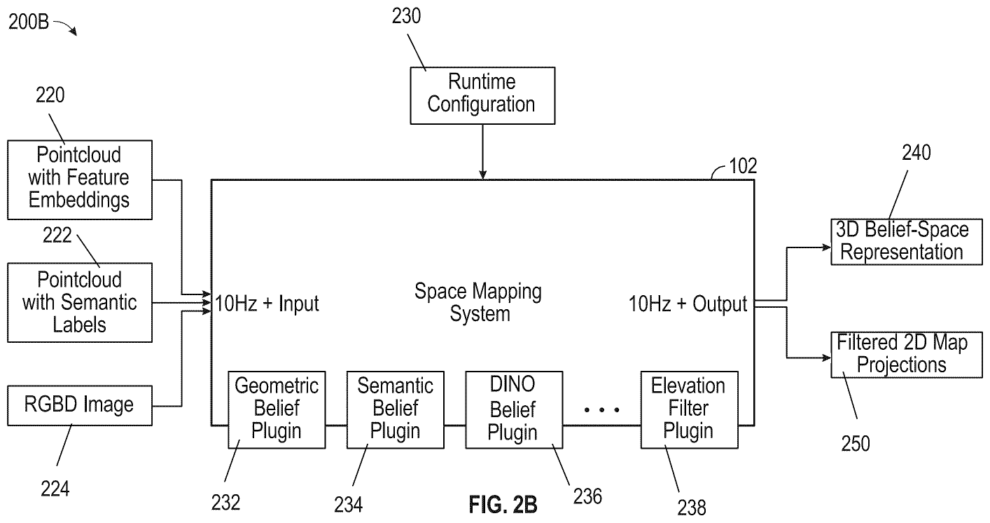

FIG. 2A illustrates an exemplary block diagram representation 200A of the space mapping system 102 as shown in FIG. 1 for the real-time map generation in the unstructured environments, in accordance with an implementation of the present disclosure.

The unstructured environments can be, for example, landscapes characterized by irregular, unpredictable, and non-systematic features, lacking clear organization and defined pathways. The unstructured environments may comprise, but not be limited to, at least one of: unknown environments, complex environments, disaster zones, extraterrestrial terrains, deep-sea exploration sites, and the like.

In an exemplary implementation, the space mapping system 102 comprises at least one of: one or more hardware processors 110, a memory unit 112, and a storage unit 204. The one or more hardware processors 110, the memory unit 112, and the storage unit 204 are communicatively coupled through a system bus 202 or any similar mechanism. The system bus 202 functions as a central conduit for data transfer and communication between the one or more hardware processors 110, the memory unit 112, and the storage unit 204. The system bus 202 facilitates the efficient exchange of information and instructions, enabling a coordinated operation of the space mapping system 102. The system bus 202 may be implemented using various technologies, including but not limited to, parallel buses, serial buses, or high-speed data transfer interfaces such as, but not limited to, at least one of a: universal serial bus (USB), peripheral component interconnect express (PCIe), and similar standards.

The memory unit 112 is operatively connected to the one or more hardware processors 110. The memory unit 112 comprises the set of computer-readable instructions in the form of the plurality of subsystems 114. The plurality of subsystems 114 comprises a data-obtaining subsystem 206, a data-handling subsystem 208, a mapping subsystem 210, a probabilistic belief-state generating subsystem 212, a Two-Dimensional (2D) projection subsystem 214, and a filter-applying subsystem 216. The one or more hardware processors 110, as used herein, means any type of computational circuit, such as, but not limited to, a microprocessor unit, microcontroller, complex instruction set computing microprocessor unit, reduced instruction set computing microprocessor unit, very long instruction word microprocessor unit, explicitly parallel instruction computing microprocessor unit, one or more graphics processing unit (GPUs), one or more central processing units (CPUs), digital signal processing unit, or any other type of processing circuit. The one or more hardware processors 110 may also include embedded controllers, such as generic or programmable logic devices or arrays, application-specific integrated circuits, single-chip computers, and the like.

The memory unit 112 may be the non-transitory volatile memory and the non-volatile memory. The memory unit 112 may be coupled to communicate with the one or more hardware processors 110, such as being a computer-readable storage medium. The one or more hardware processors 110 may execute machine-readable instructions and/or source code stored in the memory unit 112. A variety of machine-readable instructions may be stored in and accessed from the memory unit 112. The memory unit 112 may include any suitable elements for storing data and machine-readable instructions, such as read-only memory, random access memory, erasable programmable read-only memory, electrically erasable programmable read-only memory, a hard drive, a removable media drive for handling compact disks, digital video disks, diskettes, magnetic tape cartridges, memory cards, and the like. In the present implementation, the memory unit 112 includes the plurality of subsystems 114 stored in the form of machine-readable instructions on any of the above-mentioned storage media and may be in communication with and executed by the one or more hardware processors 110.

The storage unit 204 may be a cloud storage or the database 104 such as those shown in FIG. 1. The storage unit 204 may store, but not limited to, recommended course of action sequences dynamically generated by the space mapping system 102. These action sequences comprise data-obtaining, data-handling, map generating, and the like. The storage unit 204 may be any kind of database such as, but not limited to, relational databases, dedicated databases, dynamic databases, monetized databases, scalable databases, cloud databases, distributed databases, any other databases, graph databases, vector databases, and a combination thereof.

In an exemplary implementation, the data-obtaining subsystem 206 is configured to obtain sensor data from one or more sensors. The one or more sensors may comprise, but not restricted to, at least one of: one or more cameras, including red-green-blue-depth (RGBD) cameras, one or more light detection and ranging (LiDAR), one or more proprioceptive sensors, one or more environmental sensors, and the like. The one or more cameras and the one or more LiDAR capture a surrounding environment in real-time, providing information about a texture, a shape, obstacles of the terrains. The one or more proprioceptive sensors monitor an internal state of the one or more machines 116 such as wheel slippage, joint angles, and force exerted on the terrain. The internal state assists in assessing the terrain's interaction with the one or more machines 116. The one or more environmental sensors gather the sensor data on environmental conditions such as temperature, humidity, and pressure, which may influence terrain safety.

In an exemplary implementation, the data handling subsystem 208 is configured to manage the sensor data between the GPU and the CPU, ensuring flexibility in processing. The data handling subsystem 208 allows for dynamic allocation of tasks between the GPU (for parallel processing) and the CPU (for general-purpose processing), depending on the specific requirements of the mapping operation and the current resources available to the GPU and the CPU. The data handling subsystem 208 dynamically allocates processing tasks between the one or more GPUs and the one or more CPUs based on the nature of the sensor data and the computational load, ensuring optimal performance and flexibility in processing.

In an exemplary implementation, the mapping subsystem 210 is configured to perform real-time voxelization and mapping. The mapping subsystem 210 is configured to process geometric, semantic, and generic feature embeddings at high speeds, enabling the space mapping system 102 to update maps at rates exceeding 10 Hertz (Hz). This mapping subsystem 210 leverages parallel processing capabilities of the one or more GPUs to handle large volumes of data, allowing it to generate detailed and high-resolution maps in real-time.

In an exemplary implementation, the probabilistic belief-state generating subsystem 212 is configured to apply one or more probabilistic models to the embeddings obtained from the real-time mapping. Instead of creating a single fixed map, the probabilistic belief-state subsystem generates a 3D belief-state representation (e.g., 240 in FIG. 2B), which accounts for uncertainties and provides a more robust understanding of the environment. The one or more probabilistic models use a probability theory to account for uncertainty in data. In mapping, the uncertainty arises from sensor noise, ambiguities in the environment, and incomplete information. Instead of assuming that the sensor data is perfectly accurate, the one or more probabilistic models estimate the likelihood of different states and conditions being true.

In an exemplary implementation, the 2D projection subsystem 214 is configured to convert the complex 3D belief-state representation 240 into a more straightforward 2D map 250. This step is crucial for interfacing with traditional 2D planning and control systems used in the one or more machines 116. The 2D projection subsystem 214 intelligently selects the most relevant features from the 3D data to project into 2D, enabling effective use in scenarios where 2D representations are preferred for planning and control.

In an exemplary implementation, the filter-applying subsystem 216 is configured to apply filters to the 2D projections (2D maps), removing unnecessary details such as overhangs and trees. This makes the 2D maps more efficient and easier for the planning and control systems to use.

In an exemplary implementation, the space mapping system 102 is configured to generate both 3D belief-state maps (3D belief-state representations 240) and 2D projections (2D maps 250), depending on the requirements of the planning and control systems. The final map is configured to integrate seamlessly with a broad set of autonomy systems such as simultaneous localization and mapping (SLAM) systems and perception systems, especially in off-road and unstructured environments. The space mapping system 102 allows the one or more users to dynamically select which data types, filters, and projections to use during a runtime. The space mapping system 102 supports human-readable selectors, enabling precise control over the mapping process and the map generated by the space mapping system 102.

FIG. 2B illustrates an exemplary flow diagram representation 200B of the space mapping system 102 for the real-time map generation in the unstructured environments, in accordance with an implementation of the present disclosure.

In an exemplary implementation, the space mapping system 102 takes one or more inputs from various sources such as, but not limited to, at least one of: a point cloud 220 with feature embeddings, a point cloud 222 with semantic labels, RGBD images 224, and the like. The point cloud 220 with feature embeddings may be 3D data with additional information embedded into each point, such as texture and color. The point cloud 222 with semantic labels refers to the 3D data where each point is labeled with semantic information, such as identifying whether the point belongs to a tree, rock, or building. The RGBD images 224 are a type of image that includes both color (RGB) and depth (D) information, providing a rich dataset for the mapping process. The one or more inputs are processed at a rate exceeding 10 Hz, ensuring the space mapping system 102 operates in real-time.

In an exemplary implementation, one or more plugins are integrated within the space mapping system 102 to handle different types of data and processing needs. The one or more plugins is a processing model that adds specific features and functionality to the space mapping system 102. The one or more plugins may comprise, but is not limited to, at least one of a: a geometric belief plugin 232, a semantic belief plugin 234, a Detection-and-Interaction-with-Objects-using-Neural-Operators (DINO) belief plugin 236, an elevation filter plugin 238, and the like. The geometric belief plugin 232 is employed for interpreting and mapping geometric features of the environment. The semantic belief plugin 234 is employed for handling the semantic information from the one or more inputs. The DINO belief plugin 236 is a specialized plugin for a particular type of data or processing algorithmic model. The elevation filter plugin 238 may filter out or interpret elevation-related data, useful in the environments with significant height variations. The one or more plugins are selected and configured at runtime by a runtime configuration 230, providing flexibility in how the space mapping system 102 operates depending on the environment and task requirements.

After processing, the space mapping system 102 generates the maps at a rate exceeding 10 Hz. The maps may be represented in the form of at least one of the: 3D belief-space representations 240 (hereinafter referred to as a 3D map, for simplicity), filtered 2D map projections 250, and the like. The space mapping system 102 allows for dynamic adjustments during operation, enabling the selection of different data types, map targets, and filtering mechanisms based on the needs of the task.

Numerous advantages of the present disclosure may be apparent from the discussion above. In accordance with the present disclosure, the space mapping system 102 for the real-time map generation in the unstructured environments is disclosed. The space mapping system 102 enables the one or more machines 116, such as robots and drones, to operate in complex and challenging environments. By leveraging real-time voxelization and embedding-based mapping, the system 102 provides highly detailed and up-to-date representations 240 and 250 of the surroundings at speeds exceeding 10 Hz.

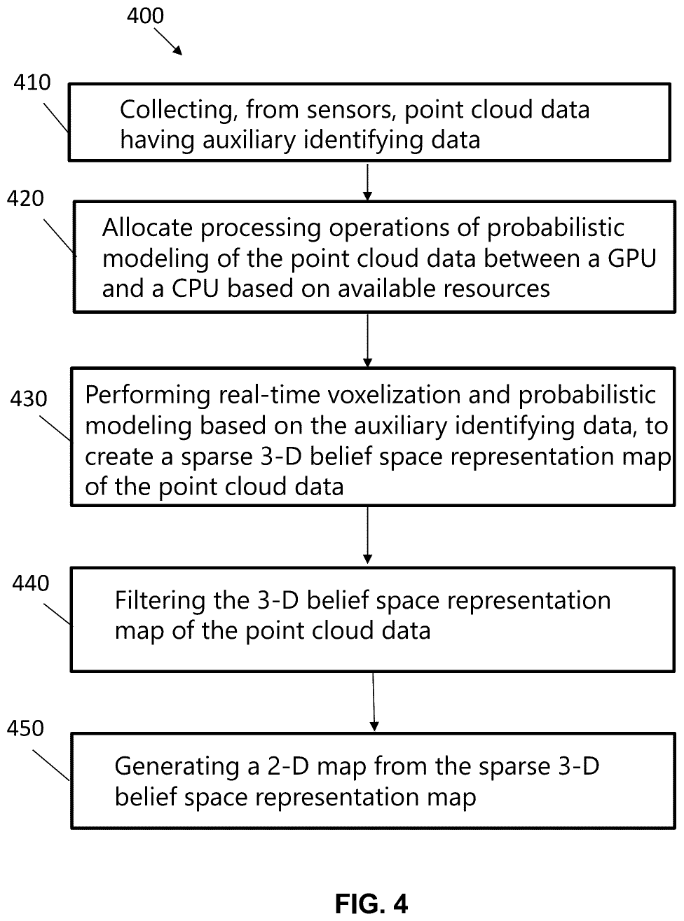

As will be discussed below in more detail with reference to FIGS. 4-6, the dynamic allocation of processing the tasks between the one or more GPUs and the one or more CPUs ensures optimal performance and flexibility, while the use of the sparse hierarchical data structures enhances memory efficiency. The space mapping system's ability to generate both the 3D maps 240 and the simplified 2D maps 250 allows for effective integration with various planning and control systems. Additionally, the probabilistic modeling of the environment supports a more robust and reliable understanding of the world, making it ideal for the one or more machines navigating unpredictable and unstructured terrains. While maintaining high-levels of performance, the system implements flexible run-time mechanisms to dictate in high-granularity what data-types and mapping targets are executed.

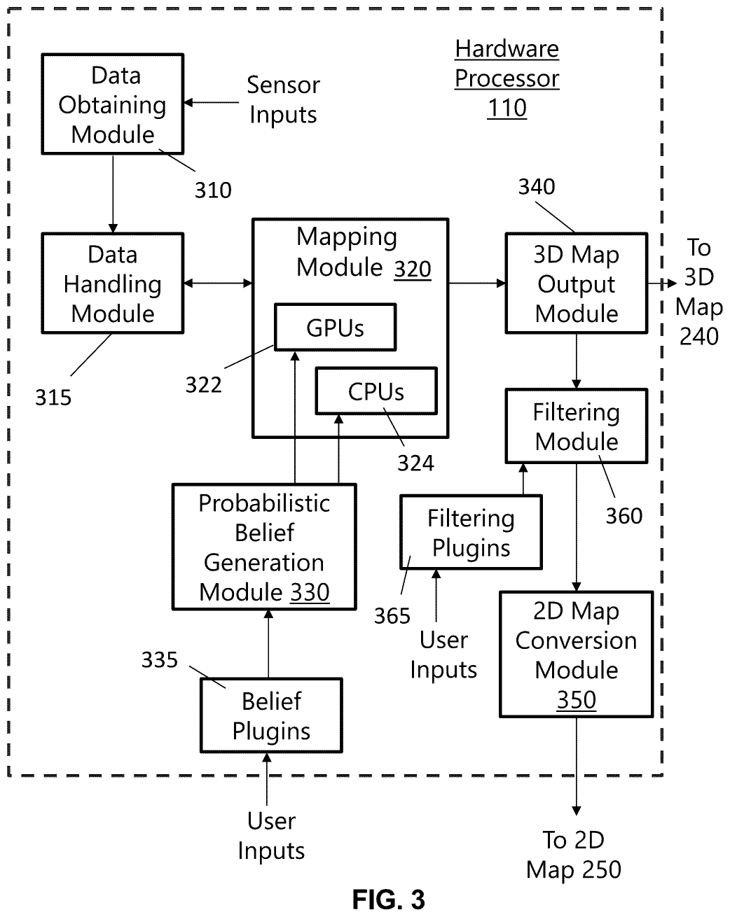

Turning next to FIG. 3, a diagram is shown of an example implementation of processing in the space mapping system 102 of FIGS. 1, 2A and 2B for real-time map generation in accordance with aspects of the disclosure. In particular, FIG. 3 shows modules of a hardware processor 110 (for example, in FIGS. 1 and 2A) for carrying out operations based on instructions from the plurality of subsystems 114 showing in FIG. 2A.

To begin with, a data obtaining module 310 of the space mapping system 102 receives sensor input from sensors (not shown) which obtain data from the point clouds such as 220 and 222 of FIG. 2B. The point cloud data can include one or more of feature embeddings, somatic labels, and geometric labels, as shown in FIG. 2B. Red-green-blue-depth (RGBD) image data (e.g., 224), etc., of the point cloud can also be provided to the data obtaining module. The data obtaining module is operated based on instructions provided by the data obtaining subsystem 206 of the memory unit 112.

The point cloud data obtained by the data obtaining module 310 is output to a data handling module 315. The data handling module 315 provides operations for managing the obtained sensor data from the point clouds 220 and 222 in a manner to allocate the obtained sensor data either to the one or more GPUs 322 and the one or more CPUs 324 in a mapping module 320. The allocation of the point cloud data to the one or more GPUs 322 and/or CPUs 324 is based upon determinations by the data handling module 315 of the current resources available to the GPUs 322 and the CPUs 324, as well as the nature of the sensor data and the computational load, ensuring optimal performance and flexibility in processing. These data handling operations are performed under the direction of the instructions provided by the data handling subsystem 208 of the memory unit 112.

The mapping module 320 is configured to perform real-time voxelization on the point cloud data as well as to process the point cloud data, and particularly the embedding and labeling of the point cloud data, in a high-speed manner under the directions of the instructions from the mapping subsystem 210 of the memory unit 112. To this end, the mapping module 320 operates in conjunction with a probabilistic belief generation module 330 to utilize one or more probabilistic models for processing the embedding and labels in the point cloud data received from the data obtaining module 310 and the data handling module 315. Instructions from the probabilistic belief-state generating subs-system 212 are utilized by the probabilistic belief generation module 330 for controlling the operations of the GPUs 322 and CPUs 324 of the modeling module 320 for creating a sparse 3D belief space representations 240 of the point cloud data.

In particular, by the combination of the use of the probabilistic belief generation module 330, utilizing one or more probability theories to account for uncertainties in the point cloud data, utilizing the embedding and labels in the data, and the high-speed processing obtained by parallel processing and real-time voxelization, using the GPUs 322 and CPUs 324, the sparse 3D belief space representation map 340 of the point cloud data can provide a high-quality representation of the point clouds 220 and 222 with considerably less data than actually exists in the actual point clouds themselves (and in the collected sensor data). This allows for significantly speeding up processing, and for avoiding exceeding the processing capacities of the GPU's 322 and CPUs 324 in the mapping module 320.

Still referring to FIG. 3, the probabilistic belief generation module 330 can be reconfigured based on user inputs via one or more belief plugins 335. These belief plugins 335 can include geometric belief plugins 232, semantic belief plugins 234, and DINO belief plugins 236, as shown in FIG. 2B. The belief plugins 335 can be controlled by user inputs to allow a user to control the operations of the probabilistic belief generation module 330, and, accordingly, change the 3D map creation performed by the GPU and CPU of the mapping module 320.

As also shown in FIG. 3, a 3D map output module 340 is provided to output the data from the mapping module 320 to form the 3D map 340, or, more accurately, the sparse 3D belief-space representation 240 of the point cloud data determined by the sensors and input into the space mapping space mapping system 102. In accordance with aspects of the present disclosure, once the 3D map 240 is generated, the 2D map 250 can be generated periodically by a 2D map conversion module 350 which converts the data of the sparse 3D map 240 by using only data which is necessary for the 2D map 250. The 2D map 250 is particularly useful when the maps are provided to robots, drones and similar devices in an unstructured environment.

In accordance with other aspects of the present disclosure, filtering can be applied by a filtering module 360 to the 3D map 240 provided by the 3D map output module 340 in order to eliminate further unnecessary data from the 2D map 250. This filtering can include filtering out known sensor noise, which is present in the various sensors which provide the sensor inputs to the data obtaining module. The filter can also be directed to filtering out specific geometric data which is regarded as unnecessary for the robot (such as overhanging trees, etc.).

Although the filtering module 360 is shown in FIG. 3 as filtering the 3D map output before generating the 2D map, the filtering can be provided at any desired location in the hardware processor 110. It is further noted that the filtering operations of the filtering module 360 can be controlled by filtering plugins 365, which, and turn, can be controlled by user inputs. The operations of both the belief plugins 335 and the filtering plugins 365 can also be controlled automatically by environmental sensors, or other sensors, rather than, or an addition to, user inputs.

FIG. 4 shows a flowchart 400 for implementing the real-time map generation in accordance with aspects of the disclosure. At step 410 of the flowchart 400, the point cloud data is collected from the sensors (such as the point cloud data with feature embeddings, the point cloud data with semantic and/or geometric labels and RGBD images from appropriate sensors, which can include LiDAR sensors and RGBD camera sensors). As noted previously, the point cloud data includes auxiliary identifying data, such as embeddings and labels, as discussed above.

At step 420, processing operations of the mapping module 320 (see FIG. 3) with regard to the point cloud data can be allocated to various elements of the processor 110 based on a number of factors. For example, the allocation of processing operations to one or more GPUs 322, and one or more CPUs 324 can be performed by the data handling module 315 shown in FIG. 3 based on the available resources of the GPUs and CPUs, to ensure maximum efficiency in carrying out the processing. In addition, or alternatively, the data handling subsystem 208 can provide instructions to the data handling module 315 to dynamically allocate processing tasks between the one or more GPUs 322 and the one or more CPUs 324 based on the nature of the sensor data and the computational load, ensuring optimal performance and flexibility in processing.

At step 430, probabilistic modeling is performed by the GPUs 322 and CPUs 324 under the control of the probabilistic belief generation module 330 of FIG. 3. This probabilistic modeling, together with the real-time voxelization and the parallel processing of the GPUs 322 and CPUs 324, serves to provide a highly efficient creation of a sparse 3D belief space representation map 240 from the sensed point cloud data. This sparse 3D belief space representation map 240 has considerably less data than the total data in the point cloud itself. However, based on the effective use of real-time voxelization, probabilistic modeling and parallel processing in the mapping module 320, the sparse 3D belief space representation map 240 can provide a highly accurate 3D representation of the actual point cloud data being sensed by the sensors, with a minimum of necessary data being used to create the 3D belief space representation map.

Once a 3D belief space representation map 240 has been created, filtering can be carried out, for example, by the filtering module 360 shown in FIG. 3, under the control of the filter applying subsystem 216 of the memory unit 112 of FIG. 2A. In step 450, the filtered 3D belief space representation map 240 can be used to periodically generate a 2D map 250. Such a 2D map 250 is of particular usefulness for robots in unstructured environments, particularly because it can readily be periodically updated to adjust appropriately to environmental changes in the unstructured environment. Typically, the periodic projection from the 3D map 240 to the 2D map 250 can either match the LiDAR sensor rate, for example, running at 10 Hertz or can run at a faster rate, such as at 5 Hertz.

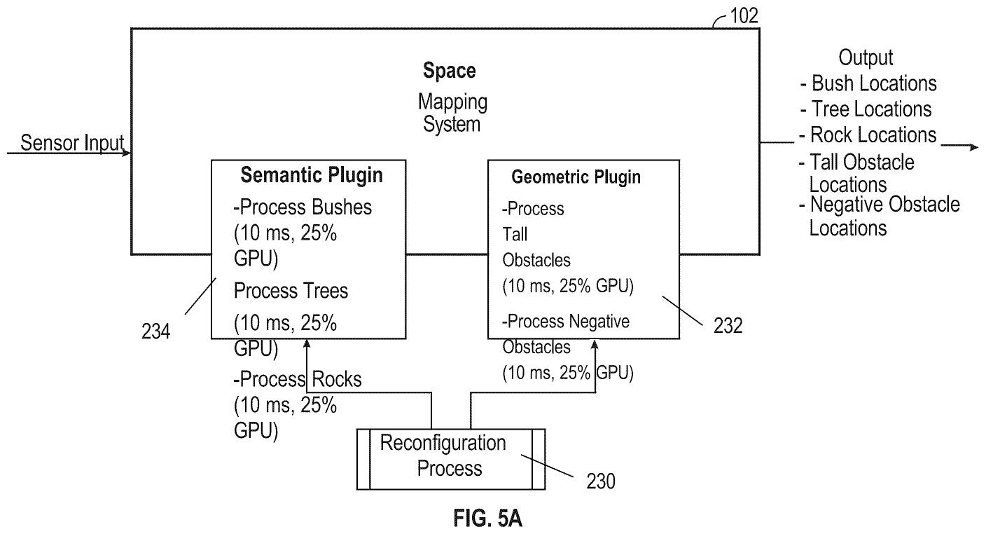

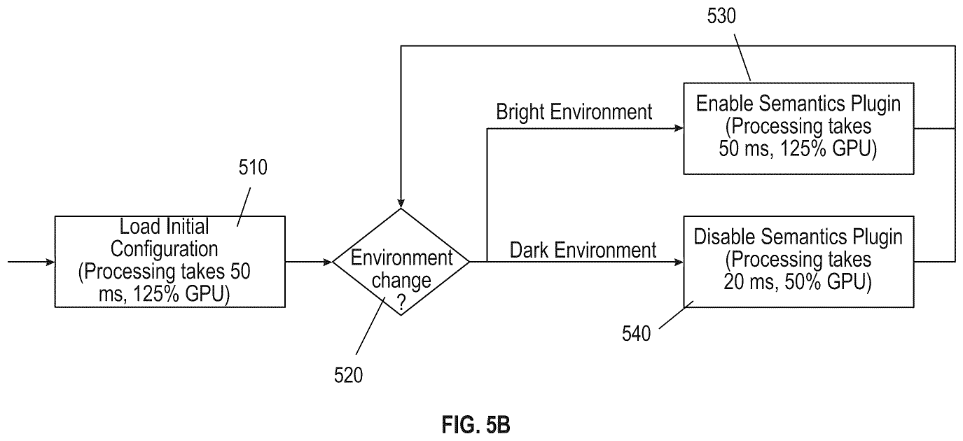

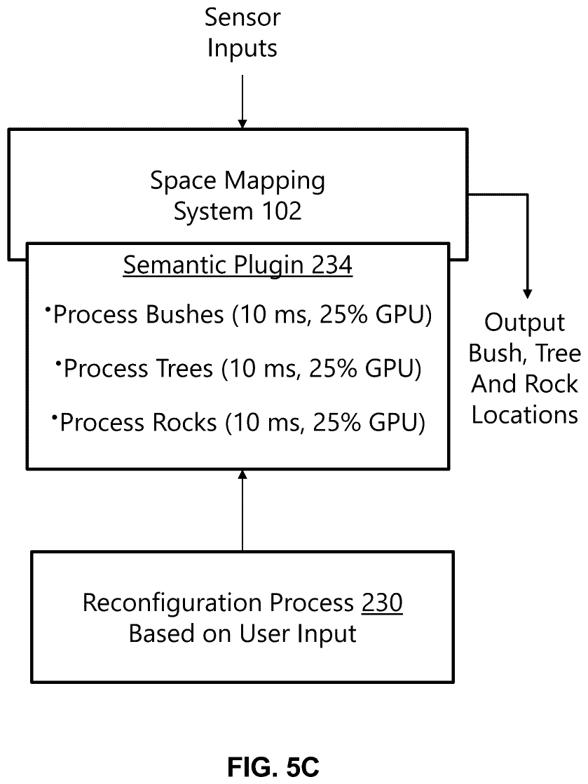

FIGS. 5A, 5B and 5C show reconfiguring operations using plugins for changing the map generation in accordance with aspects of the disclosure. Referring to FIG. 5A, an arrangement is shown regarding how the semantic belief plugin 234 and a geometric belief plugin 232 can change the processing operations in the space mapping system 102 based by a reconfiguration process 230. The reconfiguration process 230 can either be user inputs or computer controlled inputs, including AI inputs, for making adjustments to the space mapping system 102 based, for example, upon sensed changes in an environment.

In the example shown in FIG. 5A, the semantic belief plugin 234 and the geometric belief plugin 232 can be controlled by the reconfiguration process 230 in order to secure map outputs (for both the 3D and 2D maps) directed to emphasizing bush locations, tree locations, rock locations, tall obstacle locations and negative obstacle locations (e.g., ditches terrain, depressions, etc.). The reconfiguration process 320 provides data to the semantic belief plugin 234 and the geometric belief plugin 232 regarding the processing of the desired object locations. To this end, the semantic belief plugin 234 in the example of FIG. 5A directs the space mapping system 102 to process the point cloud data for bushes, trees, and rocks with parameters of 10 ms and 25% GPU. Similarly, the reconfiguration process 230 directs the geometric belief plugin 232 to direct the space mapping system 102 to process for tall obstacles and negative obstacles, again at 10 ms and 25% GPU. The result is that the 3D map 240 and the 2D map 250 will provide the desired emphasis on determining the locations of bushes, trees, rocks, tall obstacles, and negative obstacles, all of which are important for the operation of robots, drones, etc., in unstructured environments in order to avoid the robot or drone from running into such obstacles. FIG. 5C shows a simplified operation using just a semantic belief plugin 234 in conjunction with the space mapping system 102 specifically to control the operations for providing maps emphasizing bush, tree, and rock locations in accordance with the reconfiguration process being based on a user input.

FIG. 5B shows an example of enabling or disabling the semantic belief plugin 234, depending on sensing changes in the environment. For example, in step 510, an initial load configuration can be loaded in for the semantic belief plugin 234 for processing at 50 ms, 125% GPU. After checking for an environment change in step 520, if it is determined that there is a bright environment, the semantic belief plugin 234 can be enabled in accordance with the initial configuration in step 530. On the other hand, in step 540, if it is determined that it is a dark environment, the semantic belief plugin 234 can be disabled since it will be ineffective in a dark environment. In that case, the reconfiguration process can revise the semantic belief plugin 234 operation to process at 20 ms, 50% GPU to accommodate the dark environment.

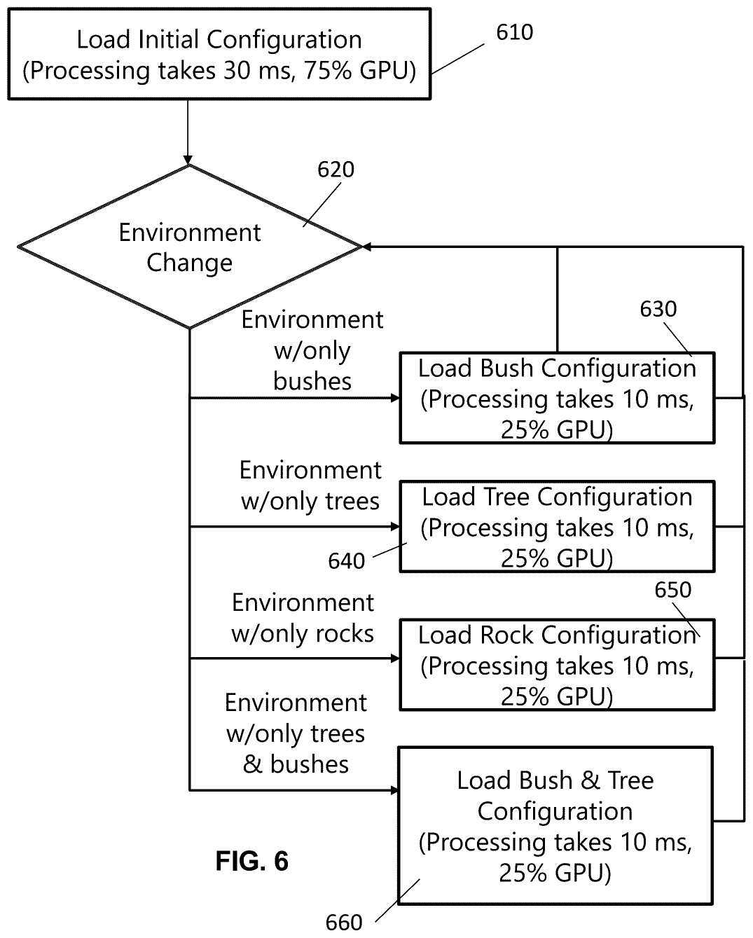

FIG. 6 shows operations for adjusting the semantic belief plugin 234 to adjust processing in the space mapping system 102 in response to environment changes in accordance with aspects of the disclosure. In FIG. 6, in step 610 an initial configuration is loaded for the processing to take 30 ms, 75% GPU. With this initial configuration of the semantic belief plugin 234, the processing will take place within these parameters for bushes, trees and rocks. However, in step 620, in response to sensing environment changes, the semantic belief plugin 234 can be reconfigured to control the space mapping system 102 to perform more limited operations. In other words, in the example shown in FIG. 6, the operations can be configured, via the semantic belief plugin 234, to load data only for bushes (step 630), data only for trees (step 640), data only for rocks (step 650), or data only for trees and bushes (step 660) for forming the 3D and 2D maps. It is noted, of course, that the specifics shown in FIG. 6 are solely for purposes of example to illustrate how the mapping operations of the space mapping system 102 can be adjusted, via the plugins, to be tailored for providing very specific emphasis in the maps, depending upon inputs from users and/or computer or AI control controllers.

The above-described systems, methods and computer program products provide for the following unique technical solutions and advantages in the technical field of map generation for robots, drones and similar devices in unstructured environments. To begin with, the present disclosure provides technical advantage of massively parallel, efficient voxelization and mapping implemented in C++ and CUDA. Previous mapping systems for robotic autonomy in unstructured environments often leverage Python for ease-of-development and extensibility. The implementations of the present disclosure, on the other hand, can implement mapping in highly-efficient C++ and CUDA for maximum performance, which is a significant technical advantage over previous mapping systems.

As also described herein, implementations of the present disclosure provide dynamic GPU/CPU interoperable buffers and plugins for mapping. In the past, mapping systems implemented in C++ often are restricted to a static feature set once compiled which are bound to either a CPU or GPU respectively. The implementations of the present disclosure allow flexibility in what features execute where in the space mapping system.

Also, as noted herein, sparse hierarchical data-structures are provided for memory efficiency and flexibility. To enable a dynamic feature set, a sparse hierarchical data-structure can be implemented, in accordance with the present disclosure, to achieve both flexibility and memory efficiency at large-scales.

In addition, implementations of the present disclosure allow for run-time selection of data types and map targets. In particular, while maintaining high-levels of performance, the system can implement flexible run-time mechanisms to dictate in high-granularity what data-types and mapping targets are executed.

The above-described space mapping system 102 allows for real-time mapping of geometric, semantic, and generic feature embeddings. By leveraging massive parallelization and efficient data-structures the space mapping system 102 is able to achieve real-time mapping at large scale across complex feature embeddings at rates exceeding 10 Hz.

The above-described space mapping system 102 also allows for probabilistic modelling of embeddings to form a robust belief-state representation. The system applies statistical modeling over various embeddings to form a belief-state representation rather than a single expectation, enabling a robust world understanding by consumer modules.

Further, the above-described space mapping system 102 also allows for periodic projection from complex 3D representations to expressive 2D representations. To enable classical 2D planning and control systems, the system implements projections from complex 3D belief-states into 2D maps.

The above-described space mapping system 102 also provides a filtering system for 2D projection based on belief-state representations. To improve performance of consumer planning and control systems, filtering is performed on the data projected into 2D based on belief-states as shown in the sparse 3D belief state representation. This allows complex geometry like overhangs and trees to be removed when appropriate or abstracted to other representations, enabling consumer systems to reason about complex representations in 2D.

Further, the above-described space mapping system 102 also allows for run-time selection of filters and projections to 2D based on human-readable embedding descriptions. Mapping systems implemented in C++ are often restricted in what features can be enabled and disabled at run-time, using Boolean flags to enable or disable complex feature sets in bulk. The space mapping system 102 of the present disclosure allows run-time selection of filters and projections with human-readable selectors of specific embeddings and filters to form expressive 2D representations dynamically.

In addition, the above-described space mapping system 102 also allows for integration with an offroad autonomy systems. The space mapping system 102 is designed to integrate with many producer SLAM and perception systems with many input representations produced by a wide variety of sensors. It is also able to integrate with a broad set of consumer planning and control systems since it is able to dynamically determine what representations it outputs.

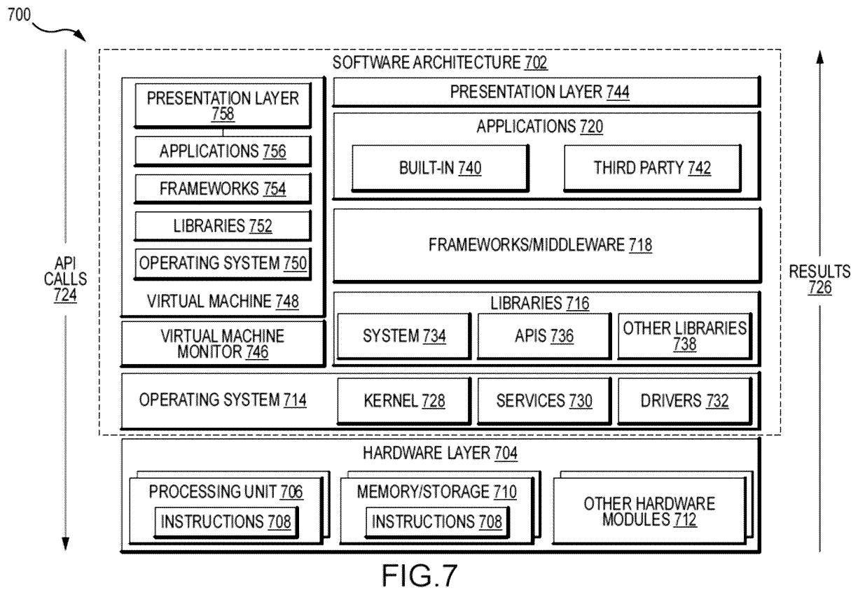

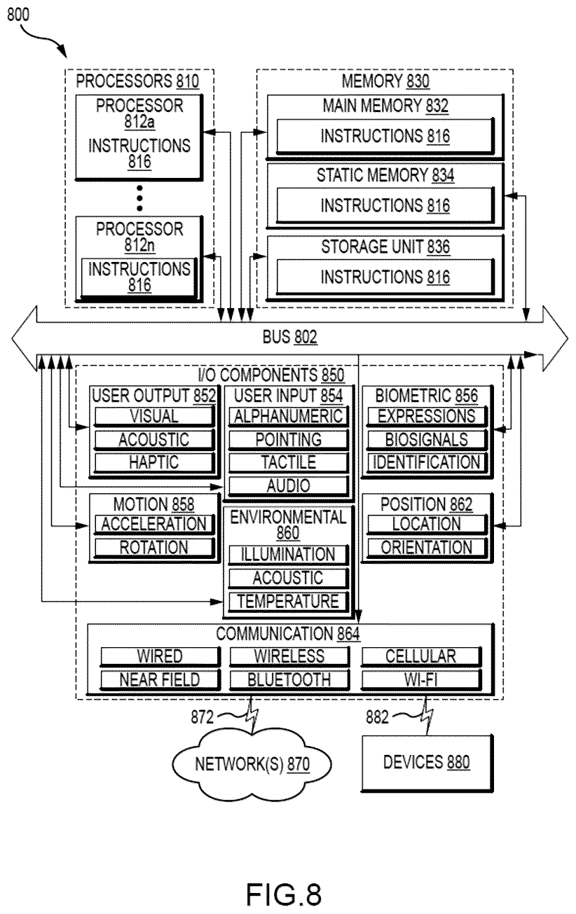

FIG. 7 is a block diagram 700 illustrating an example software architecture 702, various portions of which may be used in conjunction with various hardware architectures herein described, which may implement any of the above-described features. FIG. 7 is a non-limiting example of a software architecture, and it will be appreciated that many other architectures may be implemented to facilitate the functionality described herein. The software architecture 702 may execute on hardware such as a machine 800 of FIG. 8 that includes, among other things, processors 810, memory 830, and input/output (I/O) components 850. A representative hardware layer 704 is illustrated and can represent, for example, components of the satellite communication system 100 and ROHC implementations of FIGS. 1-6. The representative hardware layer 704 includes a processing unit 706 and associated executable instructions 708. The executable instructions 708 represent executable instructions of the software architecture 702, including implementation of the methods, modules and so forth described herein. The hardware layer 704 also includes a memory/storage 710, which also includes the executable instructions 708 and accompanying data. The hardware layer 704 may also include other hardware modules 712. Instructions 708 held by processing unit 706 may be portions of instructions 708 held by the memory/storage 710.

The example software architecture 702 may be conceptualized as layers, each providing various functionality. For example, the software architecture 702 may include layers and components such as an operating system (OS) 714, libraries 716, frameworks 718, applications 720, and a presentation layer 744. Operationally, the applications 720 and/or other components within the layers may invoke API calls 724 to other layers and receive corresponding results 726. The layers illustrated are representative in nature and other software architectures may include additional or different layers. For example, some mobile or special purpose operating systems may not provide the frameworks/middleware 718.

The OS 714 may manage hardware resources and provide common services. The OS 714 may include, for example, a kernel 728, services 730, and drivers 732. The kernel 728 may act as an abstraction layer between the hardware layer 704 and other software layers. For example, the kernel 728 may be responsible for memory management, processor management (for example, scheduling), component management, networking, security settings, and so on. The services 730 may provide other common services for the other software layers. The drivers 732 may be responsible for controlling or interfacing with the underlying hardware layer 704. For instance, the drivers 732 may include display drivers, camera drivers, memory/storage drivers, peripheral device drivers (for example, via Universal Serial Bus (USB)), network and/or wireless communication drivers, audio drivers, and so forth depending on the hardware and/or software configuration.

The libraries 716 may provide a common infrastructure that may be used by the applications 720 and/or other components and/or layers. The libraries 716 typically provide functionality for use by other software modules to perform tasks, rather than rather than interacting directly with the OS 714. The libraries 716 may include system libraries 734 (for example, C standard library) that may provide functions such as memory allocation, string manipulation, file operations. In addition, the libraries 716 may include API libraries 736 such as media libraries (for example, supporting presentation and manipulation of image, sound, and/or video data formats), graphics libraries (for example, an OpenGL library for rendering 2D and 3D graphics on a display), database libraries (for example, SQLite or other relational database functions), and web libraries (for example, WebKit that may provide web browsing functionality). The libraries 716 may also include a wide variety of other libraries 738 to provide many functions for applications 720 and other software modules.

The frameworks 718 (also sometimes referred to as middleware) provide a higher-level common infrastructure that may be used by the applications 720 and/or other software modules. For example, the frameworks 718 may provide various graphic user interface (GUI) functions, high-level resource management, or high-level location services. The frameworks 718 may provide a broad spectrum of other APIs for applications 720 and/or other software modules.

The applications 720 include built-in applications 740 and/or third-party applications 742. Examples of built-in applications 740 may include, but are not limited to, a contacts application, a browser application, a location application, a media application, a messaging application, and/or a game application. Third-party applications 742 may include any applications developed by an entity other than the vendor of the particular platform. The applications 720 may use functions available via OS 714, libraries 716, frameworks 718, and presentation layer 744 to create user interfaces to interact with users.

Some software architectures use virtual machines, as illustrated by a virtual machine 748. The virtual machine 748 provides an execution environment where applications/modules can execute as if they were executing on a hardware machine (such as the machine 800 of FIG. 8, for example). The virtual machine 748 may be hosted by a host OS (for example, OS 714) or hypervisor, and may have a virtual machine monitor 746 which manages operation of the virtual machine 748 and interoperation with the host operating system. A software architecture, which may be different from software architecture 702 outside of the virtual machine, executes within the virtual machine 748 such as an OS 750, libraries 752, frameworks 754, applications 756, and/or a presentation layer 758.

FIG. 8 is a block diagram illustrating components of an example machine 800 configured to read instructions from a machine-readable medium (for example, a machine-readable storage medium) and perform any of the features described herein. The example machine 800 is in a form of a computer system, within which instructions 816 (for example, in the form of software components) for causing the machine 800 to perform any of the features described herein may be executed. As such, the instructions 816 may be used to implement modules or components described herein. The instructions 816 cause unprogrammed and/or unconfigured machine 800 to operate as a particular machine configured to carry out the described features. The machine 800 may be configured to operate as a standalone device or may be coupled (for example, networked) to other machines. In a networked deployment, the machine 800 may operate in the capacity of a server machine or a client machine in a server-client network environment, or as a node in a peer-to-peer or distributed network environment. Machine 800 may be embodied as, for example, a server computer, a client computer, a personal computer (PC), a tablet computer, a laptop computer, a netbook, a set-top box (STB), a gaming and/or entertainment system, a smart phone, a mobile device, a wearable device (for example, a smart watch), and an Internet of Things (IoT) device. Further, although only a single machine 800 is illustrated, the term ‘machine’ includes a collection of machines that individually or jointly execute the instructions 816.

The machine 800 may include processors 810, memory 830, and I/O components 850, which may be communicatively coupled via, for example, a bus 802. The bus 802 may include multiple buses coupling various elements of machine 800 via various bus technologies and protocols. In an example, the processors 810 (including, for example, a central processing unit (CPU), a graphics processing unit (GPU), a digital signal processor (DSP), an ASIC, or a suitable combination thereof) may include one or more processors 812a to 812n that may execute the instructions 816 and process data. In some examples, one or more processors 810 may execute instructions provided or identified by one or more other processors 810. The term “processor” includes a multi-core processor including cores that may execute instructions contemporaneously. Although FIG. 8 shows multiple processors, the machine 800 may include a single processor with a single core, a single processor with multiple cores (for example, a multi-core processor), multiple processors each with a single core, multiple processors each with multiple cores, or any combination thereof. In some examples, the machine 800 may include multiple processors distributed among multiple machines.

The memory/storage 830 may include a main memory 832, a static memory 834, or other memory, and a storage unit 836, both accessible to the processors 810 such as via the bus 802. The storage unit 836 and memory 832, 834 store instructions 816 embodying any one or more of the functions described herein. The memory/storage 830 may also store temporary, intermediate, and/or long-term data for processors 810. The instructions 816 may also reside, completely or partially, within the memory 832, 834, within the storage unit 836, within at least one of the processors 810 (for example, within a command buffer or cache memory), within memory at least one of I/O components 850, or any suitable combination thereof, during execution thereof. Accordingly, the memory 832, 834, the storage unit 836, memory in processors 810, and memory in I/O components 850 are examples of machine-readable media.

As used herein, “machine-readable medium” refers to a device able to temporarily or permanently store instructions and data that cause machine 800 to operate in a specific fashion, and may include, but is not limited to, random-access memory (RAM), read-only memory (ROM), buffer memory, flash memory, optical storage media, magnetic storage media and devices, cache memory, network-accessible or cloud storage, other types of storage and/or any suitable combination thereof. The term “machine-readable medium” applies to a single medium, or combination of multiple media, used to store instructions (for example, instructions 816) for execution by a machine 800 such that the instructions, when executed by one or more processors 810 of the machine 800, cause the machine 800 to perform and one or more of the features described herein. Accordingly, a “machine-readable medium” may refer to a single storage device, as well as “cloud-based” storage systems or storage networks that include multiple storage apparatus or devices. The term “machine-readable medium” excludes signals per se.

The I/O components 850 may include a wide variety of hardware components adapted to receive input, provide output, produce output, transmit information, exchange information, capture measurements, and so on. The specific I/O components 850 included in a particular machine will depend on the type and/or function of the machine. For example, mobile devices such as mobile phones may include a touch input device, whereas a headless server or IoT device may not include such a touch input device. The particular examples of I/O components illustrated in FIG. 8 are in no way limiting, and other types of components may be included in machine 800. The grouping of I/O components 850 are merely for simplifying this discussion, and the grouping is in no way limiting. In various examples, the I/O components 850 may include user output components 852 and user input components 854. User output components 852 may include, for example, display components for displaying information (for example, a liquid crystal display (LCD) or a projector), acoustic components (for example, speakers), haptic components (for example, a vibratory motor or force-feedback device), and/or other signal generators. User input components 854 may include, for example, alphanumeric input components (for example, a keyboard or a touch screen), pointing components (for example, a mouse device, a touchpad, or another pointing instrument), and/or tactile input components (for example, a physical button or a touch screen that provides location and/or force of touches or touch gestures) configured for receiving various user inputs, such as user commands and/or selections.

In some examples, the I/O components 850 may include biometric components 856, motion components 858, environmental components 860, and/or position components 862, among a wide array of other physical sensor components. The biometric components 856 may include, for example, components to detect body expressions (for example, facial expressions, vocal expressions, hand or body gestures, or eye tracking), measure biosignals (for example, heart rate or brain waves), and identify a person (for example, via voice-, retina-, fingerprint-, and/or facial-based identification). The motion components 858 may include, for example, acceleration sensors (for example, an accelerometer) and rotation sensors (for example, a gyroscope). The environmental components 860 may include, for example, illumination sensors, temperature sensors, humidity sensors, pressure sensors (for example, a barometer), acoustic sensors (for example, a microphone used to detect ambient noise), proximity sensors (for example, infrared sensing of nearby objects), and/or other components that may provide indications, measurements, or signals corresponding to a surrounding physical environment. The position components 862 may include, for example, location sensors (for example, a Global Position System (GPS) receiver), altitude sensors (for example, an air pressure sensor from which altitude may be derived), and/or orientation sensors (for example, magnetometers).

The I/O components 850 may include communication components 864, implementing a wide variety of technologies operable to couple the machine 800 to network(s) 870 and/or device(s) 880 via respective communicative couplings 872 and 882. The communication components 864 may include one or more network interface components or other suitable devices to interface with the network(s) 870. The communication components 864 may include, for example, components adapted to provide wired communication, wireless communication, cellular communication, Near Field Communication (NFC), Bluetooth communication, Wi-Fi, and/or communication via other modalities. The device(s) 880 may include other machines or various peripheral devices (for example, coupled via USB).

In some examples, the communication components 864 may detect identifiers or include components adapted to detect identifiers. For example, the communication components 864 may include Radio Frequency Identification (RFID) tag readers, NFC detectors, optical sensors (for example, one- or multi-dimensional bar codes, or other optical codes), and/or acoustic detectors (for example, microphones to identify tagged audio signals). In some examples, location information may be determined based on information from the communication components 864, such as, but not limited to, geo-location via Internet Protocol (IP) address, location via Wi-Fi, cellular, NFC, Bluetooth, or other wireless station identification and/or signal triangulation.

While various implementations have been described, the description is intended to be exemplary, rather than limiting, and it is understood that many more implementations and implementations are possible that are within the scope of the implementations. Although many possible combinations of features are shown in the accompanying figures and discussed in this detailed description, many other combinations of the disclosed features are possible. Any feature of any implementation may be used in combination with or substituted for any other feature or element in any other implementation unless specifically restricted. Therefore, it will be understood that any of the features shown and/or discussed in the present disclosure may be implemented together in any suitable combination. Accordingly, the implementations are not to be restricted except in light of the attached claims and their equivalents. Also, various modifications and changes may be made within the scope of the attached claims.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

The scope of protection is limited solely by the claims that now follow. That scope is intended and should be interpreted to be as broad as is consistent with the ordinary meaning of the language that is used in the claims when interpreted in light of this specification and the prosecution history that follows and to encompass all structural and functional equivalents. Notwithstanding, none of the claims are intended to embrace subject matter that fails to satisfy the requirement of Sections 101, 102, or 103 of the Patent Act, nor should they be interpreted in such a way. Any unintended embracement of such subject matter is hereby disclaimed.

Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element. Furthermore, subsequent limitations referring back to “said element” or “the element” performing certain functions signifies that “said element” or “the element” alone or in combination with additional identical elements in the process, method, article or apparatus are capable of performing all of the recited functions.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various examples for the purpose of streamlining the disclosure. This method of disclosure is not to be interpreted as reflecting an intention that the claims require more features than are expressly recited in each claim. Rather, as the following claims reflect, inventive subject matter lies in less than all features of a single disclosed example. Thus, the following claims are hereby incorporated into the Detailed Description, with each claim standing on its own as a separately claimed subject matter.

What is claimed is:

1. A space mapping system for map generation, comprising:
a processor; and
a memory in communication with the processor, the memory comprising executable instructions that, when executed by the processor alone or in combination with other processors, cause the space mapping system to perform functions of:
collecting, from a plurality of sensors coupled to the space mapping system, point cloud data having auxiliary identifying data;
performing real-time voxelization and probabilistic modeling using a probability theory to account for uncertainty in the point cloud data, based on the auxiliary identifying data, to create a sparse 3D belief space representation map of the point cloud data; and
generating a 2D map from the sparse 3D belief space representation map,
wherein:
the space mapping system includes at least one graphic processing unit (GPU) and at least one central processing unit (CPU) configured to perform the probabilistic modeling in cooperation with one another, and
the instructions further cause the space mapping system to dynamically allocate processing operations of at least one of the voxelization and the probabilistic modeling of the point cloud data between the at least one GPU and the at least one CPU during operations to create the sparse 3D belief space representation map.

2. The system of claim 1, wherein the auxiliary identifying data includes at least one of feature embedding, semantic labels, and geometric labels.

3. The system of claim 1, wherein the instructions further cause the space mapping system to be reconfigured in real time, using plugins in the space mapping system, in response to a user input, to change at least one of the voxelization and the probabilistic modeling to change the sparse 3D belief space representation map.

4. The system of claim 3, wherein the plugins include at least one of a human-readable geometric belief plugin, a human-readable semantic belief plugin, and a human-readable detection-and-interaction-with-objects-using-neural-operators (DINO) belief plugin.

5. The system of claim 1, wherein the instructions further cause the space mapping system to allocate processing operations of the probabilistic modeling between the at least one GPU and the at least one CPU based on at least one of a nature of the point cloud data and available resources of the at least one GPU and the at least one CPU.

6. The system of claim 1, wherein the space mapping system includes at least two graphic processing units (GPUs) configured to perform the probabilistic modeling in parallel to one another, and wherein the instructions further cause the space mapping system to allocate processing operations of the probabilistic modeling between the at least two GPUs based on available resources of each of the at least two GPU.

7. The system of claim 1, wherein the instructions further cause the space mapping system to periodically generate the 2D map from the 3D belief space representation map.

8. The system of claim 1, wherein the instructions further cause the space mapping system to filter data from the 3D belief space representation map before generating the 2D map.

9. The system of claim 8, wherein the filtering includes filtering out predetermined types of sensor noise from the point cloud data before generating the 2D map.

10. The system of claim 1, wherein the sensors include at least one of a light-detection-and-ranging (LiDAR) detector and a red-green-blue-depth (RGB) camera detector.

11. The system of claim 8, wherein the filtering includes filtering out predetermined geometric features sensed by the sensors.

12. The system of claim 8, wherein the instructions further cause the space mapping system to reconfigure the filtering in real time in response to a user input using human readable selectors of filtering characteristics.

13. A space mapping method for map generation, comprising:
collecting, from a plurality of sensors coupled to a space mapping system, point cloud data having auxiliary identifying data;
performing real-time voxelization and probabilistic modeling using a probability theory to account for uncertainty in the point cloud data, based on the auxiliary identifying data, to create a sparse 3D belief space representation map of the point cloud data; and
generating a 2D map from the sparse 3D belief space representation map,
wherein:
the space mapping system includes at least one graphic processing unit (GPU) and at least one central processing unit (CPU) configured to perform the probabilistic modeling in cooperation with one another, and
the method further comprises dynamically allocate processing operations of at least one of the voxelization and the probabilistic modeling of the point cloud data between the at least one GPU and the at least one CPU during operations to create the sparse 3D belief space representation map.

14. The method of claim 13, wherein the auxiliary identifying data includes at least one of feature embedding, semantic labels, and geometric labels.

15. The method of claim 13, wherein the method further comprises using plugins in the space mapping system to reconfigure the space mapping system in real time, in response to a user input, to change at least one of the voxelization and the probabilistic modeling to change the sparse 3D belief space representation map.

16. The method of claim 15, wherein the plugins include at least one of a human-readable geometric belief plugin, a human-readable semantic belief plugin, and a human-readable detection-and-interaction-with-objects-using-neural-operators (DINO) belief plugin.

17. The method of claim 13, wherein the method further comprises causing the space mapping system to allocate processing operations of the probabilistic modeling between the at least one GPU and the at least one CPU based on at least one of a nature of the point cloud data and available resources of the at least one GPU and the at least one CPU.

18. The method of claim 13, wherein the space mapping system includes at least two graphic processing units (GPUs) configured to perform the probabilistic modeling in parallel to one another, and wherein the method further comprises causing the space mapping system to allocate processing operations of the probabilistic modeling between the at least two GPUs based on available resources of each of the at least two GPU.

19. The method of claim 13, wherein the method further comprises causing the space mapping system to periodically generate the 2D map from the 3D belief space representation map.

20. A computer-readable storage medium having instructions stored thereon that, when executed by a processing system, perform a method comprising:
collecting, from a plurality of sensors coupled to a space mapping system, point cloud data having auxiliary identifying data;
performing real-time voxelization and probabilistic modeling using a probability theory to account for uncertainty in the point cloud data, based on the auxiliary identifying data, to create a sparse 3D belief space representation map of the point cloud data; and
generating a 2D map from the sparse 3D belief space representation map,
wherein:
the space mapping system includes at least one graphic processing unit (GPU) and at least one central processing unit (CPU) configured to perform the probabilistic modeling in cooperation with one another, and
the method further comprises dynamically allocate processing operations of at least one of the voxelization and the probabilistic modeling of the point cloud data between the at least one GPU and the at least one CPU during operations to create the sparse 3D belief space representation map.
